(19) United States
(12) Patent Application Publication
(10) Pub. No.: US 2018/0307685 A1
(43) Pub. Date: Oct. 25, 2018

(54) System and Method for Managing Regulatory Information

(71) Applicant: Veeva Systems Inc., Pleasanton, CA (US)

(72) Inventors: Rolando Sa, Lebanon, NJ (US); Jonathan Lam, Richmond Hill (CA); Shikuan Yu, Toronto (CA); Van Le, Toronto (CA); Uri Reich, Hamden, CT (US); Katharyn A. Wilber, Philadelphia, PA (US); Wei Li, Markham (CA); Lori-Ann Williams, Mississauga (CA); Jason D'Anna, Toronto (CA)

(73) Assignee: Veeva Systems Inc., Pleasanton, CA (US)

(21) Appl. No.: 15/494,337

(22) Filed: Apr. 21, 2017

(51) Int. Cl. G06F 17/30

(52) U.S. Cl. CPC G06F 17/30011; G06F 17/30864; G06F 17/30395; G06F 17/30554

(57) ABSTRACT

Systems and methods for managing regulatory information. The system comprises a submission controller, a registration controller and a submission archive controller. The submission controller may manage a submission structure, and allow users to search for documents in a content management system and add the documents to the submission structure. The registration controller may manage product registration information and health authority interactions globally, and capture, view and take actions upon product registrations. The submission archive controller may allow users to access a complete history of regulatory submissions and correspondence globally, with an easy to use interface. The three controllers reside in a single system that allows them to interact seamlessly with each other.

### BACKGROUND

The subject technology relates generally to content management systems, and more particularly to managing regulatory information.

Regulatory information management (RIM) has become a major focus among pharmaceutical companies, since it is important to meet their regulatory and compliance obligations, and improve their business processes and productivity across the global. For a pharmaceutical company, the regulatory information may include, e.g., safety reporting, product registrations, central and local requirements, submissions to health authorities, and health authority information management. However, regulatory information is traditionally captured in a multitude of disconnected central and local systems, which creates redundancies and duplication of efforts worldwide.

### SUMMARY

The disclosed subject matter relates to a system for managing regulatory documents. The system comprises a submission controller for generating a submission user interface which comprises a first area for receiving a first query for a first document, a second area for receiving a request for a submission structure for a first submission, a third area for receiving a request for a first task, and a fourth area for displaying a search result in response to the first query. The submission controller may further: in response to a request for a submission structure, display the submission structure for the first submission, wherein the submission structure for the first submission comprises a hierarchy of documentation of the first submission. The submission controller may further: in response to the first query, search a content and data management system for the first document, and display a search result in the fourth area. The submission controller may further: in response to a request for adding the first document to the submission structure for the first submission, add the first document to the submission structure.

### BRIEF DESCRIPTION OF THE DRAWINGS

FIG. 1 illustrates an example high level block diagram of a regulatory information management architecture wherein the present invention may be implemented.

FIG. 2 illustrates an example high level block diagram of a computing device.

FIG. 3 illustrates an example high level block diagram of the content management server according to one embodiment of the present invention.

FIG. 4 illustrates an example submission user interface according to one embodiment of the present invention.

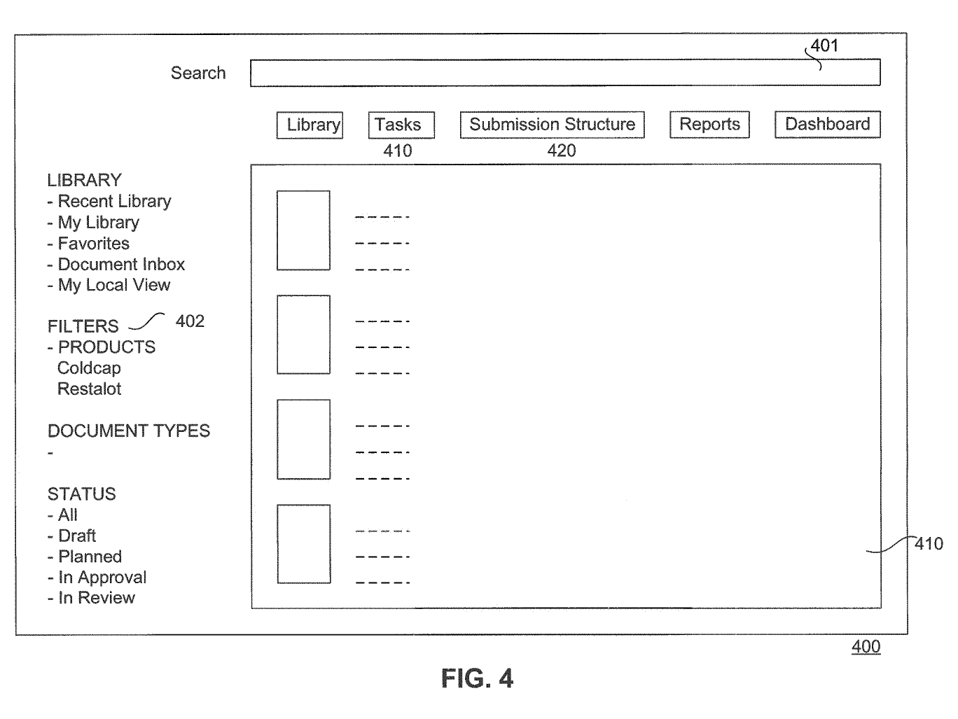

FIG. 5 illustrates an example task user interface according to one embodiment of the present invention.

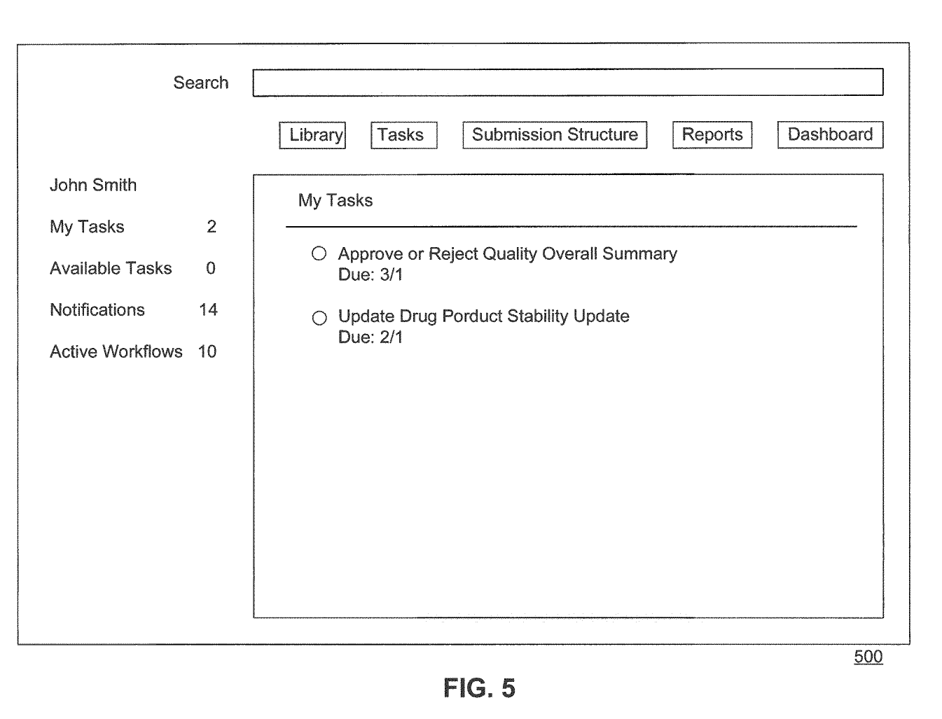

FIG. 6 illustrates an example submission structure user interface according to one embodiment of the present invention.

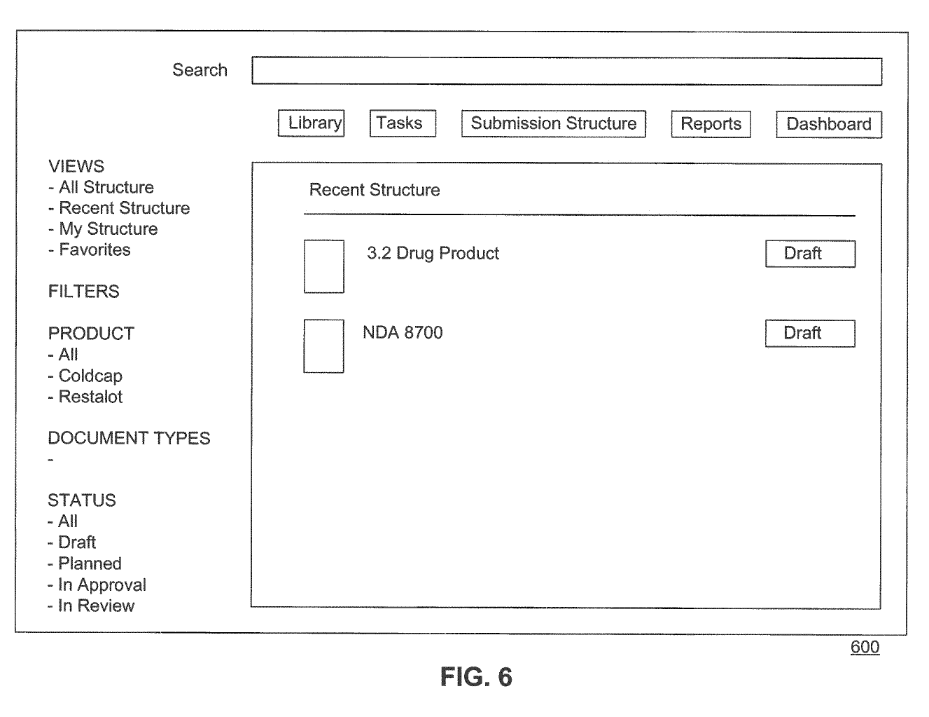

FIG. 7 illustrates an example submission structure user interface according to one embodiment of the present invention.

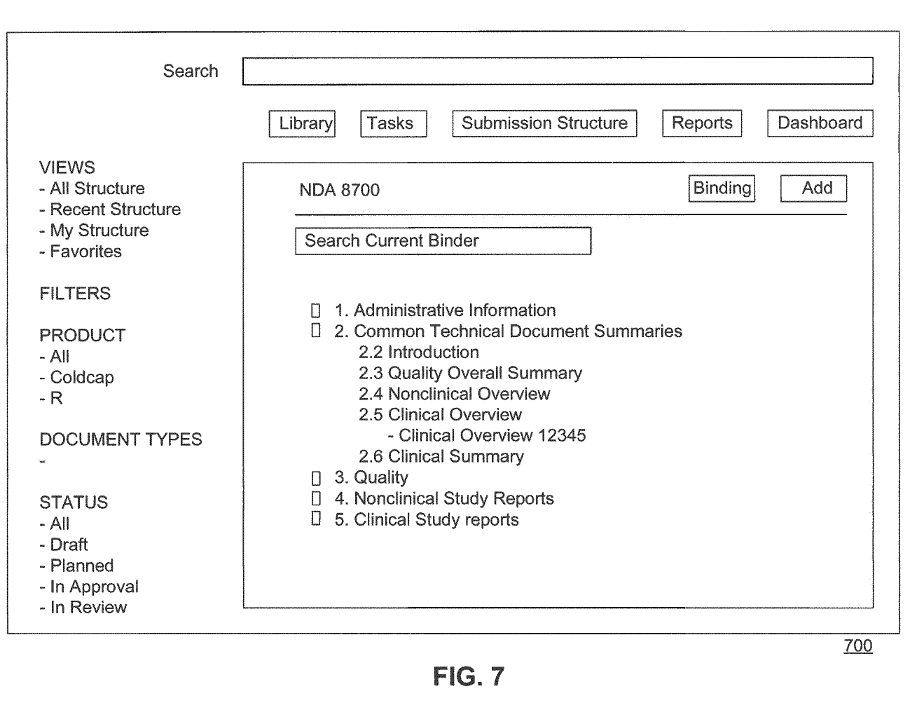

FIG. 8 illustrates an example dashboard report user interface according to one embodiment of the present invention.

FIG. 9 illustrates an example registration user interface according to one embodiment of the present invention.

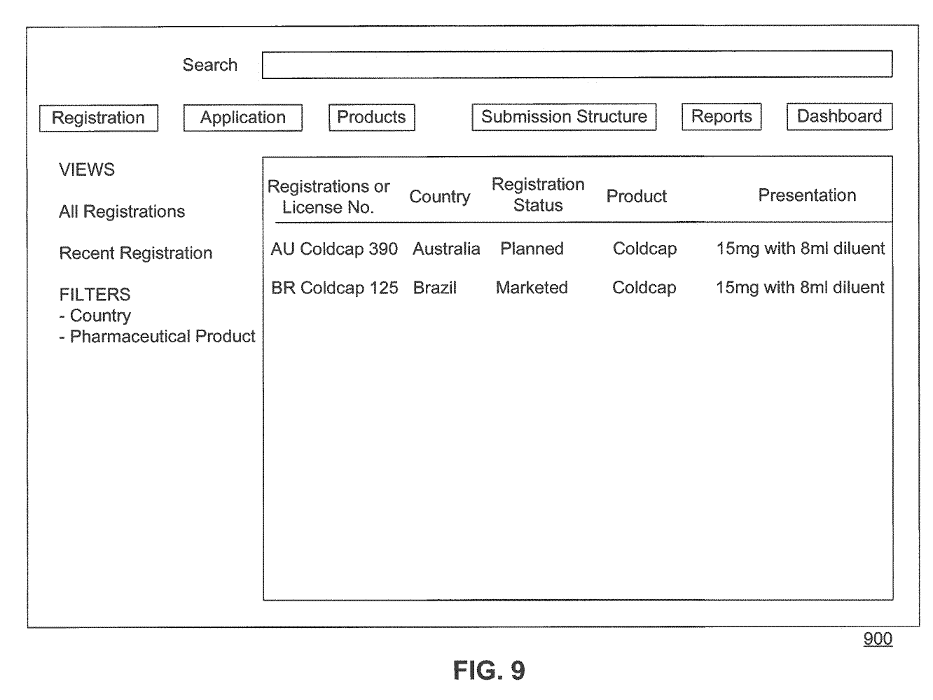

FIG. 10 illustrates an example registration report user interface according to one embodiment of the present invention.

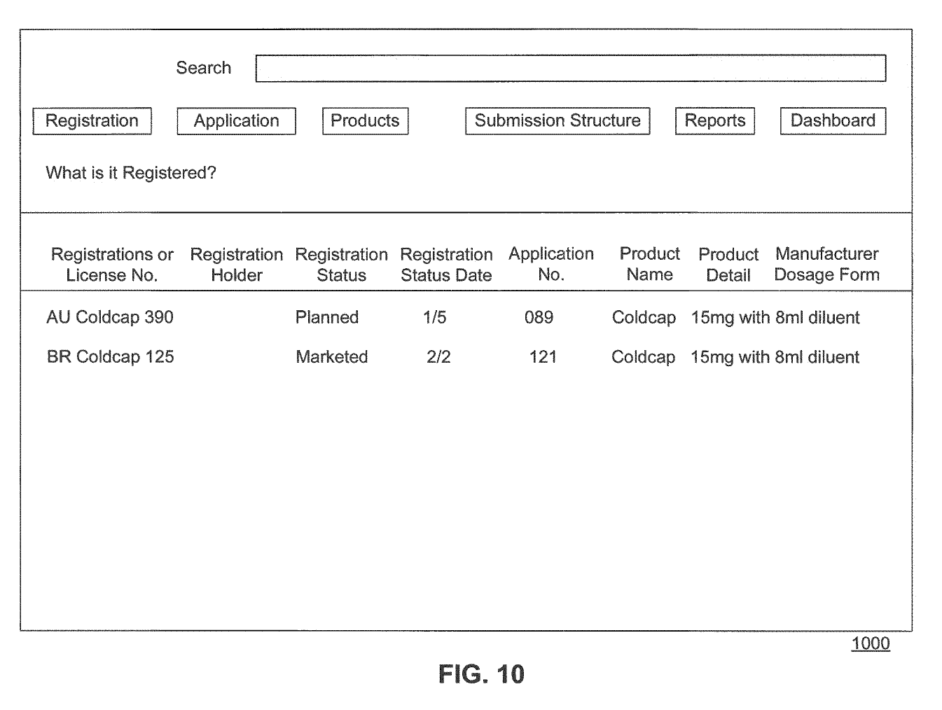

FIG. 11 illustrates an example submission archive user interface according to one embodiment of the present invention.

FIG. 12 illustrates an example submission archive user interface according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

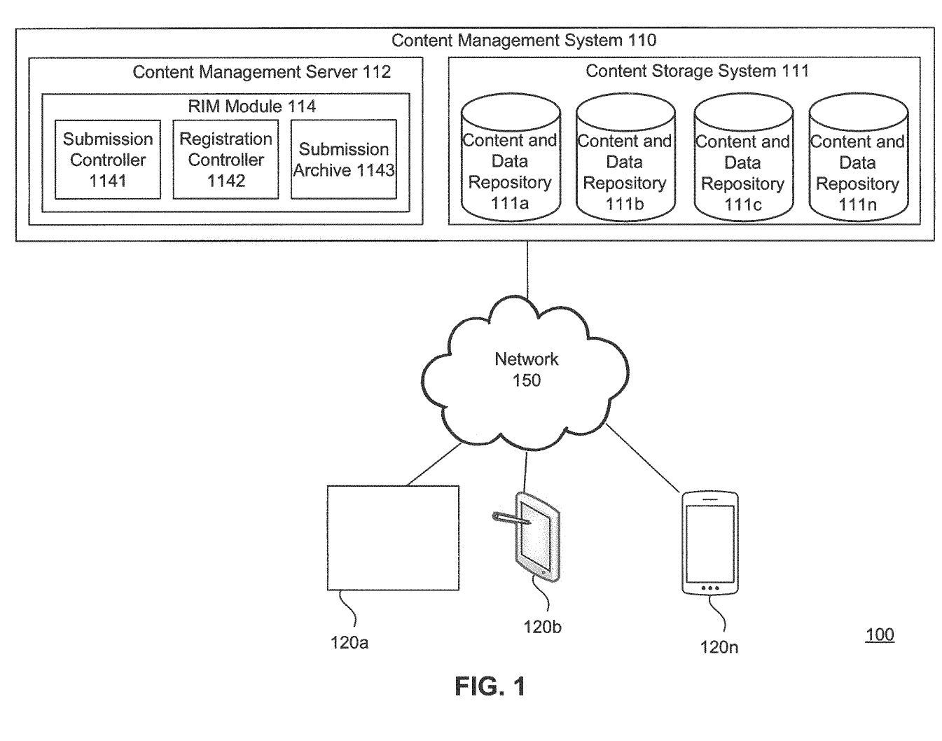

FIG. 1 illustrates an example high level block diagram of an enterprise content management architecture 100 wherein the present invention may be implemented. The enterprise may be a business, or an organization. As shown, the architecture 100 may include a content management system 110, and a plurality of user computing devices 120a, 120b, . . . 120n, coupled to each other via a network 150. The content management system 110 may include a content storage system 111 and a content management server 112. The content storage system 111 may have one or more content and data repositories, e.g., 111a, 111b, 111c, and 111n. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a-120n may be any machine or system that is used by a user to access the content management system 110 via the network 150, and may be any commercially available computing devices including laptop computers, desktop computers, mobile phones, smart phones, tablet computers, netbooks, and personal digital assistants (PDAs).

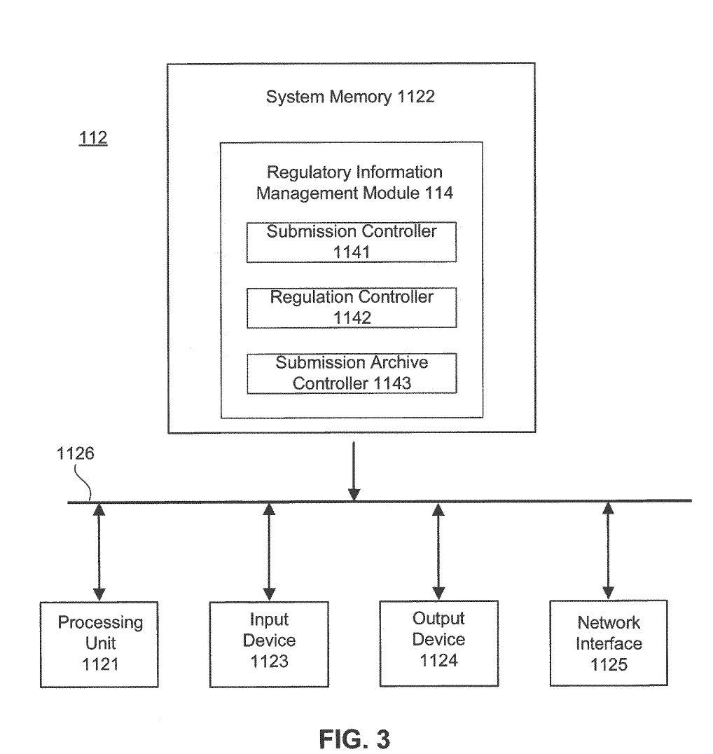

The content management server 112 is typically a remote computer system accessible over a remote or local network, such as the network 150. The content management server 112 may include a regulatory information management module 114. The regulatory information management module 114 may have a submission controller 1141, a registration controller 1142 and a submission archive controller 1143, which will be described in detail with reference to FIG. 3.

The content storage system 111 may store content that user computing devices 120a-120n may access. Each content repository (e.g., 111a, 111b, 111c or 111n) may store a specific category of content, and allow users to interact with its content in a specific business context.

In one implementation, the repository 111a may store a submissions library for regulatory content related to submissions, which may include information and submissible documents and data for the generation of submission structures, and the planning, authoring and collection of required documents. Within the submissions library, users may quickly find information they are looking for through search and filtering. The user may find drug documentation related to a product or a geographic region. The repository 111a may also store information about review and approval flow, status of documents and a filing, and dashboard reports, giving users the ability to manage the overall process.

In one implementation, the repository 111a may also store regulatory information related to product registration, which may include product registration information and health authority interactions. The product registration information may include, e.g., the associated product information, application information, application date, registration details, key registration dates, marketing status, and marketing details. In one example, the user may see all the global registrations and their status in one report. The health authority interactions may include bidirectional interactions with health authorities globally, including correspondence, commitments and queries.

In one implementation, the repository 111a may also store information for a submission archive, which may include a customer's complete global history of regulatory submissions and correspondence.

In one implementation, the repository 111a may also store source documents for the regulatory information management system.

Although the submissions library, regulatory information related to product registration, submission archive, and source documents for the regulatory information management system are shown to be stored in one repository, it should be understood that they might be stored in multiple repositories.

In one implementation, the content management system 110 may be a multi-tenant system where various elements of hardware and software may be shared by one or more customers. For instance, a server may simultaneously process requests from a plurality of customers, and the content storage system 111 may store content for a plurality of customers. In a multi-tenant system, a user is typically associated with a particular customer. In one example, a user could be an employee of one of a number of pharmaceutical companies which are tenants, or customers, of the content management system 110.

In one embodiment, the content management system 110 may run on a cloud computing platform. Users can access content on the cloud independently by using a virtual machine image, or purchasing access to a service maintained by a cloud database provider.

In one embodiment, the content management system 110 may be provided as Software as a Service (“SaaS”) to allow users to access the content management system 110 with a thin client.

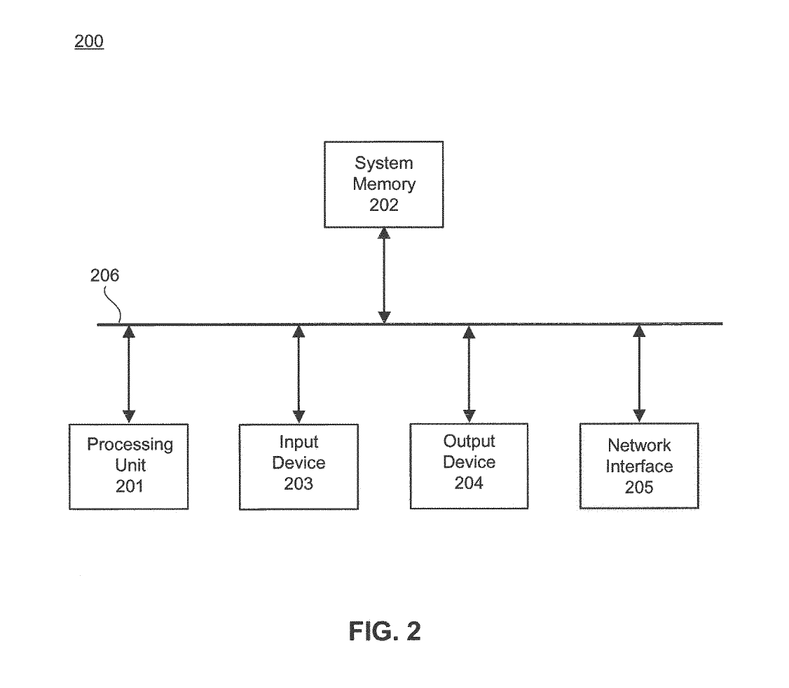

FIG. 2 illustrates an example block diagram of a computing device 200 which can be used as the user computing devices 120a-120n, and the content management server 112 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 304 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

FIG. 3 illustrates an example high level block diagram of the content management server 112 according to one embodiment of the present invention. The content management server 112 may be implemented by the computing device 200, and may have a processing unit 1121, a system memory 1122, an input device 1123, an output device 1124, and a network interface 1125, coupled to each other via a system bus 1126. The regulatory information management module 114 may be stored in the system memory 1122. The regulatory information management module 114 may have a submission controller 1141, a registration controller 1142 and a submission archive controller 1143.

The submission controller 1141 may generate a submission user interface 400 for the user to search the submission library. The user may find information he is looking for (e.g., a drug documentation related to a product) through searching via a search window 401, or filtering via filters 402. The user may also search for information specific to a geographic region, e.g., by selecting My Local View. The user interface 400 may have a window 410 for displaying documents based on the search result. In one implementation, submission is based on the drug information association (“DIA”) reference model, and the reference model classification is built based on the latest DIA standards.

When the user clicks on a Task tab 410 on the user interface 400, a task user interface 500 may be displayed, and the user may work on his/her tasks, e.g., participating review and approval flow works.

The submission controller 1141 may also manage submission structures (e.g., a New Drug Application (“NDA”) submission structure, or a Biological License Application (“BLA”) submission structure). When the user clicks on the Submission Structure tab 420 on the user interface 400, a submission structure interface 600 may be displayed. One or more submission structures may be shown on the submission structure interface 600, e.g., an NDA.

If the user selects one of the submission structures, e.g., NDA 8700, a user interface 700 for that submission structure may be displayed, which may include the hierarchy of the documentation, e.g., Administrative Information, Common Technical Document Summaries, Quality, Nonclinical Study Reports, and Clinical Study Reports. The submission structure may serve as materials for the submission. The submission structure may include placeholder documentation for expected documents, and link documents from repositories in the content storage system 111 directly into the submission structure. In one example, the user may want to add a clinical overview from the existing set of documentation. He may search for it in the content storage system 111 and drag it to the submission structure. The user may also add a link or reference of content from other repositories directly into the structure.

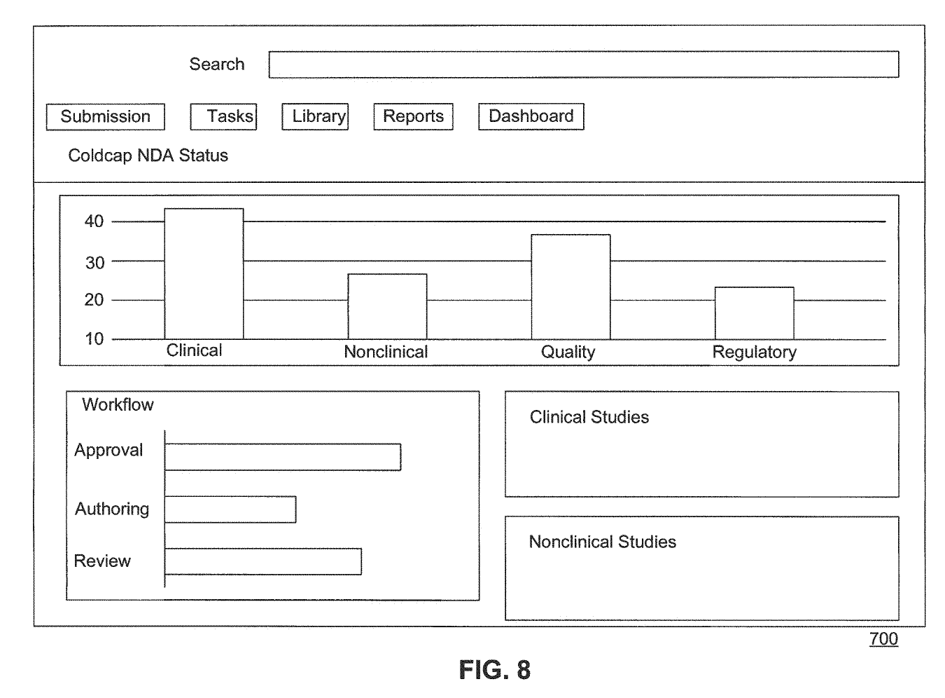

Through the process of structure assembly and management of content, the submission controller 1141 may also provide dashboard reports to give users the ability to manage the overall process through structure assembly and management of the content. As shown in FIG. 8, the dashboard report may include current status of the NDA filing, in terms of documentation, a quick look of the status of the documents, each major module, as well as any workflows. From the dashboard, users may click into any of the wedges, and be taken to the report results. From the report results, users may take actions on the documents themselves.

The registration controller 1142 may provide a powerful tool for getting visibility to global registration information, and take actions on regulatory events. All tied seamlessly with various information and functions provided by the content management system 110. The registration controller 1142 may manage registration, product and application information to help customers to make informed decisions about their business. The registration controller 1142 may display registration, product and application information on a user interface 900. If a user wants to understand the global footprint of a product Coldcap, he may click on the Report button on the user interface 900. The user interface 1000 may be presented, displaying global registrations and their status in one report. The reports are actionable, allowing users to drill in a specific registration, e.g., the AU Coldcap 390 registration. The registration record may provide key information including the register information, the associated product information, application date, and key registration dates. The registration record may be displayed on a separate user interface. Information in the registration record may be based on the IDMP data model. The registration controller 1142 may display a user interface for receiving product registration information and updates. The registration controller 1142 may further provide a comprehensive ability to not only capture and view regulatory data, but also take actions when an event occurs, including the ability to assess the impact of change, and manage global response to such change.

In addition to provide registration information, the registration controller 1142 may allow users to take actions on the regulatory business. Users may initiate an action through an event (e.g., update the Coldcap shelf life to 30 months), and assign activities to that event. The activities may be acted on by regulatory personnel that are responsible for a market. Activities may include submission responses. The user can also view the associated submission to address the activity.

Users may trace an actual submission binder representing the submissible content managed in submission library. User may also see key related content and data, such as correspondence and commitment made by the basis for the submission.

The registration controller 1142 may provide powerful, cloud based capabilities to manage product registration information and health authority interactions globally, and robust abilities to capture, view and take actions upon product registrations. It may track bidirectional interactions with health authorities globally, including correspondence, commitments and queries. With the related data features of the content management system 110, it may relate actions to be taken to product registrations. Since it is cloud based, it may tear down the virtual walls that often exist between centralized regulatory teams and their affiliates. Typically, the registration controller 1142 allows users at local sites to access and capture data related to their registration, while have visibilities into and collaborate with teams globally.

In one implementation, the registration controller 1142 is based upon the new Identification of Medicinal Products (“IDMP”) data standard for product data, and can support an interface that allows regulatory groups to standardize their registration data, while also make it easy to interface with other software applications.

The registration controller 1142 may help to improve data quality, and make it easy to collaborate with global partners, affiliates and authorities, while reducing duplication and discrepancies by providing a single centralized depository for capturing and sharing regulatory data. The registration controller 1142 may also provide robust reporting and dashboard, and make it easy to report on, and visualize key data points, such as marketing status, registration details and marketing details.

The submission archive controller 1143 may provide a powerful, cloud based capability to access a complete history of regulatory submissions and correspondence globally, with an easy to use interface. From the upload and view perspective, the submission archive controller 1143 may provide electronic common technical document (“eCTD”), non-eCTD electronic, paper and PDF submissions. With the powerful search and filter capabilities of the content management system 110, the submission archive controller 1143 may make document and data search fast and easy. Upon import, all navigation within and outside of documents is rendered to be fully navigable in the content management system 110, making it easy to follow references. In addition, there is a built-in viewer. For eCTDs, it allows users to view submissions in a current view, sequentially, or as cumulative document views.

The submission archive controller 1143 works globally. Given that it is cloud based, it may provide a centralized archive for sharing global filings across the enterprise without requiring any additional software. In addition, with its powerful, easy to use searching and filtering capability, the submission archive makes it easy to find previously submitted information, in order to respond quickly to internal and external queries.

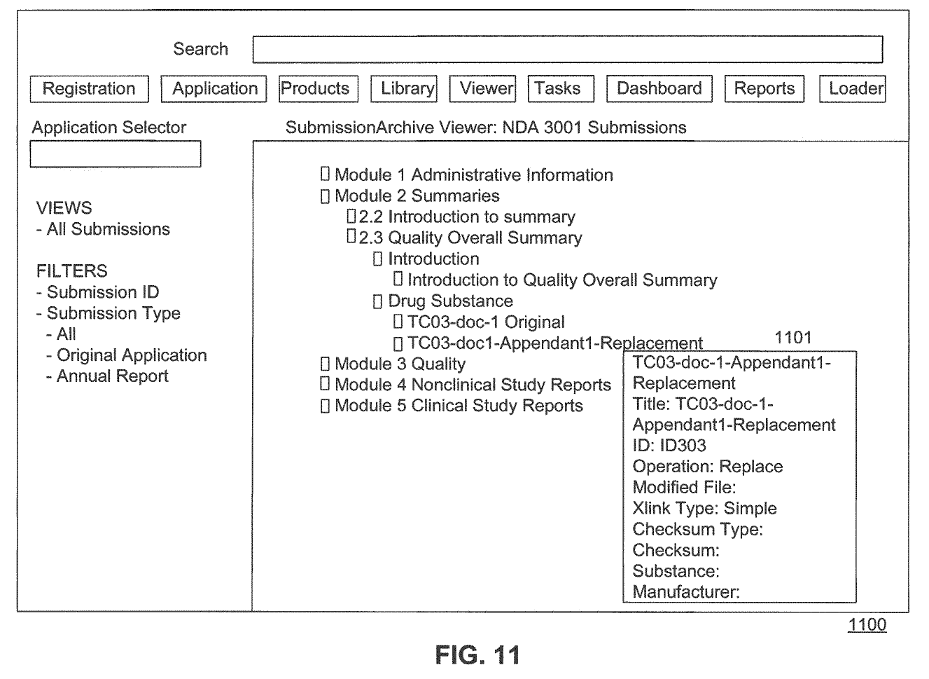

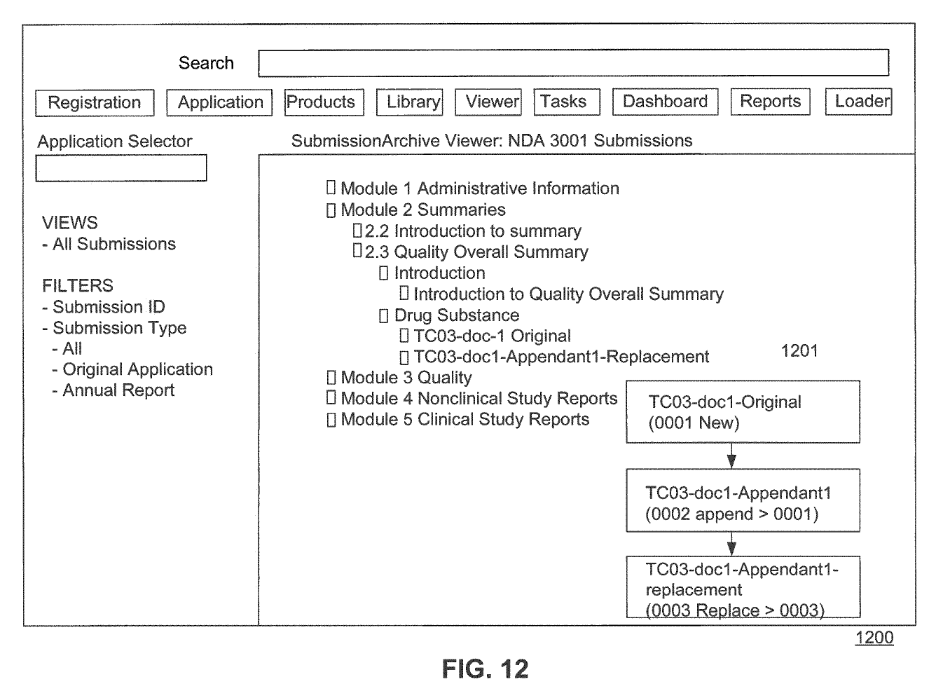

The submission archive controller 1143 may assist the process from submission planning to content authoring and publishing, by storing and viewing published output. The submission archive controller 1143 may display user interfaces in FIG. 11 and FIG. 12 for users to search and see the previously submitted information. As shown in FIG. 11, users can navigate to the viewer tab and select the application to view. Through the viewer, the user and navigate to published output, and get information on published facts. For a summary document, users can see published info from the backbone, and also historical context, as shown in FIG. 12. Users can view the output the content management system 110, and use the native navigation of the document, including bookmarks and cross document hyperlinks.

In previous solutions, published output resides on uncontrolled file drives, disconnected from the source content. The submission archive controller 1143 addresses the need to securely map published output while providing global accessibility by storing the published output and allowing users to access the published output.

In one implementation, the regulatory information management system may use the same data model for data objects for submission, product registration, submission archive, and source document management, and share data (e.g., product information and manufacturer information) among these functions, so as to avoid duplicate data entry, management and tracking. Health authorities define data requirements, and the regulatory information management system may provide information about the health authority data requirements.

Customers may decide the data and documents to submit based on the information about the health authority data requirements, depending on the type of the submission. An example data model for Product is shown below. The bolded names are the objects in the system, in italics are the actual names of the records.

Product—Cold Medicine (this is a Generic Name)

Drug Products
DP1—Coldcap A (this is the marketed name)
Product Details (this is how it's sold. Each one of these could be manufactured by a different manufacturer, and could contain different active substances or inactive ingredients)
   45 mg vial
   45 mg tablet
   90 mg vial
   90 mg tablet
DP2—Coldcap B

Product Details
30 mg capsule
60 mg capsule

The system of the present invention unites contributors, partners, and affiliates in the cloud with a single destination for regulatory documents. Global and regional submission dossiers harmonize planning and provide real-time visibility into submission readiness. Globalizing processes becomes substantially easier with a single authoritative source for submissions content. Global alignment may maintain greater control over the distribution and tracking of documents that affiliates submit to local authorities. The system may track the progress of documents through actionable reports and dashboards, mitigating risks to submission timelines, and enabling continuous visibility of the documents. The system may eliminate manual processing to speed submission assembly and improve SOP compliance and speed to market globally. It may automate tracking and reporting by authoring, exchanging, and assembling documents directly within the content management system 110.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A system for managing regulatory information, comprising:
a submission controller for:
generating a submission user interface which comprising a first area for receiving a first query for a first document; a second area for receiving a request for a submission structure for a first submission, a third area for receiving a request for a first task, and a fourth area for displaying a search result in response to the first query;
in response to the request for the submission structure for the first submission, displaying the submission structure for the first submission, wherein the submission structure for the first submission comprises a hierarchy of documentation of the first submission;
in response to the first query, searching a content and data management system for the first document, and displaying a search result in the fourth area; and
in response to a request for adding the first document to the submission structure for the first submission, adding the first document to the submission structure.

2. The system of claim 1, wherein the submission controller further:
in response to a second query, searches the content and data management system for a second document,
obtains a link pointing to the second document in the content and data management system, and
adds the link to a place for the second document in the submission structure for the first submission.

3. The system of claim 1, wherein the submission structure for the first submission further comprises: a placeholder for a third document.

4. The system of claim 3, wherein the submission controller further:
in response to a third query, searches the content and data management system for a third document;
displays the third document in the fourth area, and
adds the third document to the placeholder in the submission structure for the first submission.

5. The system of claim 1, wherein the submission controller further: searches the content management system for a fifth document based on a selected filter.

6. The system of claim 1, wherein the submission controller further: generates a task interface in response to a request, wherein the task interface comprises a task in progress.

7. The system of claim 1, wherein the submission controller further: generates a dashboard user interface in response to a request, wherein the dashboard user interface comprises a status of a task.

8. The system of claim 1 further comprising: a registration controller for displaying a user interface for receiving product registration information.

9. The system of claim 8, wherein the registration controller further:
displays a registration user interface which comprises an area for receiving a request for a report; and
displays a report user interface in response to the request for the report, wherein the report use interface comprises a first product registration and its status.

10. The system of claim 8, wherein the registration controller further: displays a registration record which provides product information, and key registration dates.

11. The system of claim 8, wherein the registration controller further: tracks bidirectional interactions with a health authority.

12. The system of claim 8, wherein the registration controller further: relates actions to be taken to a product registration based on data in the content and management system.

13. The system of claim 8, further comprising: a submission archive controller for displaying a submission archive user interface to enable access to previously submitted information.

14. The system of claim 13, wherein the submission archive user interface further enables access to correspondence related to the submission.

15. The system of claim 1, further comprising: a submission archive controller for displaying a submission archive user interface to enable access to previously submitted information and correspondence related to the submission.

16. A regulatory information management system, comprising:
a registration controller for
displaying a user interface for receiving product registration information;
displaying a registration user interface which comprises an area for receiving a request for a report; and
displaying a report user interface in response to the request for the report, wherein the report user interface comprises a first product registration and its status.

17. The system of claim 16, wherein the registration controller further: displays a registration record which provides product information, and key registration dates.

18. The system of claim 16, wherein the registration controller further: tracks bidirectional interactions with a health authority.

19. The system of claim 16, wherein the registration controller further: relates actions to be taken to a product registration based on data in the content and management system.

20. The system of claim 16, further comprising: a submission archive controller for displaying a user interface to enable access to previously submitted information and correspondence related to the submission.
